(19) United States
(12) Patent Application Publication
(10) Pub. No.: US 2023/0368047 A1
(43) Pub. Date: Nov. 16, 2023

(54) FACILITATING CONVERSATIONS WITHIN AN ONLINE DATING SERVICE

(71) Applicant: Meta Platforms, Inc., Menlo Park, CA (US)

(72) Inventors: Jordan Springstroh, San Francisco, CA (US); Charmaine Ching Man Hung, San Francisco, CA (US); Nathan Andrew Sharp, San Francisco, CA (US); Xue Ding, Los Altos, CA (US)

(21) Appl. No.: 16/866,575

(22) Filed: May 5, 2020

(51) Int. Cl. G06N 5/04; G06N 20/00; G06Q 50/00

(52) U.S. Cl. CPC G06N 5/04; G06N 20/00; G06Q 50/01

(57) ABSTRACT

The disclosed computer-implemented method may include identifying potential matches for a user of an online dating service. The method may also include accessing at least a portion of ephemeral content produced by the user. Then, prior to matching at least one of the potential matches with the user, the method may include surfacing the accessed ephemeral content to at least one of the potential matches to facilitate conversation between the user and the potential matches. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a computing environment in which the embodiments described herein may operate.

FIG. 2 is a flow diagram of an exemplary method for facilitating conversation between potential matches in an online dating service.

FIG. 3 illustrates an embodiment of a graphical user interface (GUI) that shows a landing screen for an online dating service.

FIGS. 4A-4D illustrate a progressive GUI animation in which a user selects a potential match, and views and interacts with content associated with the potential match.

FIGS. 5A-5D illustrate a progressive GUI animation in which a user conducts a conversation with a match.

FIGS. 6A-6C illustrate a progressive GUI animation in which a user views potential matches based on their association with selected events or groups.

FIGS. 7A-7C illustrate a progressive GUI animation in which a user selects content from another media platform to post in the online dating service.

FIGS. 8A-8G illustrate a progressive GUI animation in which a user selects content in another media platform and selects which content to push to other media platforms or to an online dating service.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The popularity of online dating continues to grow as users from all parts of the world meet up online. Some online dating services allow users to meet each other virtually and then potentially physically in the real world. Most online dating services match their users to each other in one of two ways: 1) the online dating service gathers a large amount of upfront data from the users and then implements a complex back-end algorithm that matches the users to others that share the highest number of similar interests, or 2) the online dating service presents the user with a series of pictures in which the user swipes in one direction to add the subject to a pool of potential matches, or swipes in the other direction to remove the person from consideration as a match.

These approaches thus create matches using either an impersonal behind-the-scenes algorithm or using simple, instantaneous physical attraction to the person. Neither of these approaches allow a gradual, get-to-know-you process where users can interact with each other on a limited basis to learn more about each other over time, before matching. The embodiments described herein facilitate a process in which users may converse with each other and share content with each other while still in the matchmaking, get-to-know-you process. Users may indicate interest in another user if desired, or move on to learn more about other users within the online dating service. The embodiments described herein also allow users to take content posted on alternative social media platforms and synchronize that content to their profile on the online dating service. This allows seamless transitioning of content between platforms, even in cases where the online dating service is siloed and walled off from other social media platforms.

The present disclosure is generally directed to systems and methods for facilitating conversation between potential matches in an online dating service. As will be explained in greater detail below, embodiments of the present disclosure may include identifying potential matches for a user of an online dating service, accessing at least a portion of content produced by the user and, prior to matching a potential matches with the user, surfacing the accessed ephemeral content to at least one of the potential matches to facilitate conversation between the user and the potential matches.

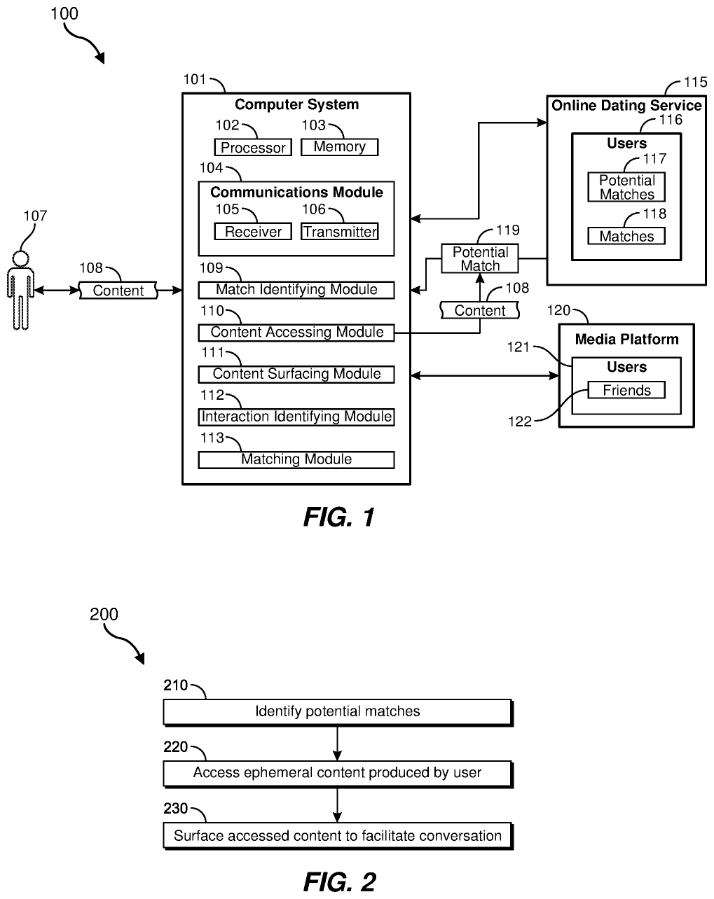

FIG. 1, for example, illustrates an environment in which a conversation may be initiated and carried out between potential matches in an online dating service. The computing environment 100 of FIG. 1 includes a computer system 101 which may be used to facilitate such conversations. The computer system 101 may be substantially any type of computer system including a local computer system or a distributed (e.g., cloud) computer system. The computer system 101 includes at least one processor 102 and at least some system memory 103. The computer system 101 also includes program modules for performing a variety of different functions. The program modules may be hardware-based, software-based, or may include a combination of hardware and software. Each program module uses computing hardware and/or software to perform specified functions, including those described herein below.

For example, the communications module 104 may communicate with other computer systems. The communications module 104 may include wired or wireless communication means that receive and/or transmit data to or from other computer systems. These communication means may include hardware radios including, for example, a hardware-based receiver 105, a hardware-based transmitter 106, or a combined hardware-based transceiver capable of both receiving and transmitting data. The radios may be WIFI radios, cellular radios, Bluetooth radios, global positioning system (GPS) radios, or other types of radios. The communications module 104 may interact with databases, mobile computing devices (such as mobile phones or tablets), embedded, or other types of computing systems.

The computer system 101 also includes a match identifying module 109. The match identifying module 109 may be configured to match online dating service users (or simply “users” herein) to each other. A “potential match,” as the term is used herein, between users indicates that the users have met certain qualifications or criteria that indicate that the users would likely be interested in each other. A “match” between users indicates that the two users have already interacted enough to declare that the two are to be paired together as a match. Once matched with each other, the two matched users may carry on “conversations” with each other which may include verbal conversations, video conversations, textual conversations, shared stories or posted content (e.g., pictures, videos, text, websites, links to external content, etc.), interactions with stories or other posted content, or other forms of communicating with each other. Some forms of interaction or communication may only be available to matched users, while some forms of communication or interaction may be available to all users of the online dating service.

Thus, the match identifying module 109 may monitor interactions between users, including determining when a user has viewed, liked, disliked, commented on, or otherwise interacted with another user's post. These interactions, along with potentially other information including bibliographic data, may be used to match the dating interests of one user to another. Such bibliographic data may include personal information about each user including, but not limited to, interests, hobbies, education, age, gender, sexual orientation or preference, height, weight, eye color, hair color, or other information or other user preferences. Within the online dating service, all such bibliographic information may be provided on a voluntary basis by each member, and any preferences for certain personal characteristics or features may also be voluntarily provided by each member. The match identifying module 109 may thus use substantially any type of interaction data and/or bibliographic or other information to identify matches or potential matches between users.

Accordingly, in one example, match identifying module 109 looks at users 116 in online dating service 115 and identifies one or more potential matches 117. These potential matches 117 may be users that are viable matches for each other based on available interaction and bibliographic information. The match identifying module 109 may also identify users that qualify as matches 118 for each other. Each user of the online dating service 115 may optionally provide content that is posted to the online dating service 115. As will be explained below, this type of content may include substantially any type of text, pictures, videos, stories, or other content. The content accessing module 110 may access the content 108 and use that content (or interactions with that content) when identifying potential matches 117.

The content surfacing module 111 may then surface or present the content 108 produced by user 107 to one or more potential matches 117 including, perhaps, a specific potential match 119 which is one of the group of potential matches 117. The specified potential match 119 will then see the content 108 in their content feed and may choose to interact with the content by liking it, disliking it, commenting on it, replying to it with a story, replying to it with a video or voice message, or interacting with the content 108 in some other way. The interaction identifying module 112 may then identify which forms of interaction took place between the potential match 119 and the content 108, and the matching module 113 may determine, based on the interactions, that the user 107 and the potential match 119 are to be matched. This pre-match and post-matching process may allow users to converse and gradually get to know each other over time. This overall process will be described further below with regard to method 200 of FIG. 2.

Features from any of the embodiments described herein may be used in combination with one another in accordance with the general principles described herein. These and other embodiments, features, and advantages will be more fully understood upon reading the following detailed description in conjunction with the accompanying drawings and claims.

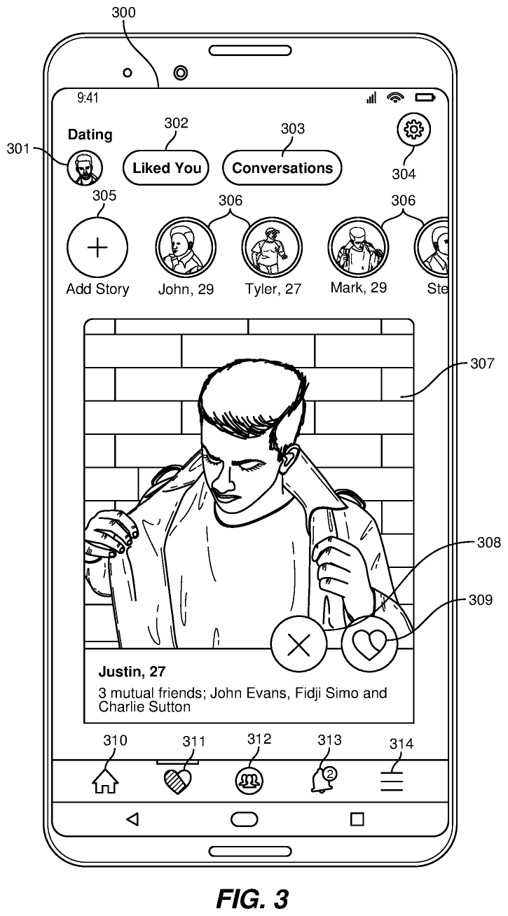

FIG. 2 is a flow diagram of an exemplary computer-implemented method 200 for facilitating conversation between potential matches in an online dating service. The steps shown in FIG. 2 may be performed by any suitable computer-executable code and/or computing system, including the systems illustrated in FIG. 1. In one example, each of the steps shown in FIG. 2 may represent an algorithm whose structure includes and/or is represented by multiple sub-steps, examples of which will be provided in greater detail below. Method 200 will be described with reference to computing environment 100 of FIG. 1 as well as FIGS. 3-8G.

Method 200 of FIG. 2 includes, at step 210, identifying one or more potential matches for a user of an online dating service. As noted above, the group of potential matches 117 may include one or more similar characteristics or features, or may be linked based on interactions with each other's posts, or may be members of a specific group that is focused on an event or a common interest. Within the online dating service 115, users may post content (e.g., 108) including videos, pictures, text, stickers, emojis, stories, interactive games, or other content that they want to share with others. In some cases, this content may be ephemeral content. As such, the content 108 may be posted at a certain time and may have a specified lifespan before it is automatically removed by the online dating service 115. In some cases, this lifespan is 24 hours, while in other cases, the lifespan is shorter or longer than 24 hours. In some embodiments, the lifespan of the ephemeral content is set by the user that posted the content 108. In other cases, the lifespan of posted content is set by the online dating service 115. This content, regardless of lifespan, may be made available to all users of the online dating service 115, or to certain subsets of users. The content may be created by the users, or may be gathered from other sources. Regardless of how the users acquired the content, this content will be said to be “produced” by the various users in the description herein.

Thus, as users produce content (e.g., as user 107 produces content 108), that content may be posted publicly or privately on the online dating service 115. At least in some cases, the user 107 may control which posts are public, and which posts are private. Moreover, the user 107 may be able to control which posts are visible to potential matches and which posts are only available to matches. Still further, as will be explained below, the user 107 may specify which content is to be cross-posted from other sources. For example, the user 107 may have other social media accounts aside from the online dating service 115. In such cases, the user 107 may post on those social media accounts and then share that content to the online dating service 115. When cross-posting from other media platforms (e.g., media platform 120 of FIG. 1, in which the user may have their own separate set of friends 122 within the platform's users 121), the posts surfaced to the online dating service 115 may be made available to potential matches 117 and/or matches 118. Any interactions with those posts may stay within the online dating service 115. Thus, any likes, comments, reply stories, or other interactions may remain within the online dating service 115 and may not be shared back to the user's accounts on the other media platforms (e.g., 120).

At step 220 of Method 200, the content accessing module 110 accesses the content 108 produced by the user 107. Then, at step 230 of Method 200, before determining that a potential match 117 is a match 118 for the user, the content surfacing module 111 may surface the accessed content 108 to at least one of the potential matches to facilitate conversation between the user and the potential match(es). Thus, for example, if user 107 produced a story, that story would be surfaced to potential match 119 (along with perhaps other potential matches 117). Those potential matches may then have the opportunity to interact with the story, including liking, commenting, etc. Based on those interactions, the interaction identifying module 112 may determine which types of interactions occurred, may determine the length or brevity of those interactions, may determine the frequency of those interactions, or may determine other characteristics of the user 107 and the potential match's interactions. The potential match 119 may, for example, view and like the story, indicating some interest (perhaps romantic interest) in the user 107.

Additionally, the potential match 119 may comment on the story, indicating an additional level of interest. The potential match 119 may then come back hours later and comment again, or add an emoji sticker, or add a reply post. The potential match 119 may also look back at previous posts by the user 107 (whose lifespans have not expired) and interact with those posts if desired. These cumulative interactions may act as indicators that the user 107 and the potential match 119 may be a good match for each other. The matching module 113 may consider these interactions when determining whether to match the two users. By allowing users to casually view others' posts and interact with those posts, the users may slowly get to know each other over time, prior to being matched together. This paradigm, in contrast to existing platforms that simply have the user swipe left or swipe right to determine a match, allows users to talk with each other, flirt with each other, find out more about each other, and interact in ways not previously possible in online dating services.

In some embodiments, the interaction identifying module 112 of computer system 101 may determine that at least one of the potential matches 117 has interacted with the surfaced ephemeral content produced by user 107. In this determination, the interaction identifying module 112 may also determine which types of interactions have occurred. This may include tracking the amount of time spent viewing the posts, tracking likes, tracking comments, tracking reply posts, tracking other interaction mechanisms including electronic games, texts, emails, instant messages, or tracking other interactions.

In some cases, the interaction identifying module may assign a certain value or viability ranking to each interaction and may determine, based on the combined ranking value, whether to match the potential match to the user 107. In cases where the amount of interaction or the type of interaction (or both) have met a sufficient minimum threshold level, the matching module 113 may match the potential match 119 that interacted with the surfaced ephemeral content 108 to the user 107 based on the potential match's interaction with the user's content 108. This match may be undone by the user or by the potential match if one or the other determines that the match is not desirable.

In some cases, after a potential match 119 has been matched to the user 107, the user and the match 118 may be permitted to provide different types of interaction with their respective content than are allowed with potential matches. For instance, at least in some embodiments, any one or more of the above-listed types of interaction may only be made available to users that have matched with each other. For instance, commenting on a post, or replying with a story, or sending a private instant message, starting a private conversation, or some other forms of interaction may only occur between matched users. In other cases, all forms of interaction are available regardless of matched or potentially matched status.

In still other cases, the matching of a user to another user may change the content that is available to see, or may change the timeline for a given post, at least with respect to that user. For example, if some content is only available to matched users, that content may not be visible to potential matches. If a potential match becomes a match with the user 107, that potential match may then see posts that were previously siloed and hidden from that match. In some cases, the posts that are newly available to the match may have an increased lifespan (e.g., up to the full 24 hours or other specified lifespan or up to some shortened lifespan). This may afford the newly matched user time to see the posts that are reserved only for matched users. Accordingly, at least in some cases, even if ephemeral content produced by the user 107 has been posted with an established lifespan after which it will be removed, that lifespan may be renewed for some period of time up to (or beyond) the original lifespan, in order to allow the new match to peruse and interact with those posts. The amount of time for the initial lifespan, for the renewed lifespan, the decision on whether some content is available only to matched users, and other settings may be set by policies which may be controlled by end users and/or by system administrators.

Turning now to FIG. 3, an embodiment of a graphical user interface is provided. The online dating service 115 of FIG. 1, for example, may include a corresponding graphical user interface (GUI) that facilitates interaction with the online dating service. The GUI 300 may represent a landing screen or home screen, and may present a variety of information to the user 107 including new potential matches for the user as well as content associated with those potential matches. The GUI 300 of FIG. 3 may include multiple different buttons or other interactive elements including elements 301-314. It will be understood here that, although many of the interactive elements are shown as buttons that may be clicked or touched on a touchscreen, the GUI 300 may be displayed on substantially any type of mobile or stationary computer system, and that the interactive elements may include toggles, sliders, links, buttons, or any other interactive user interface element.

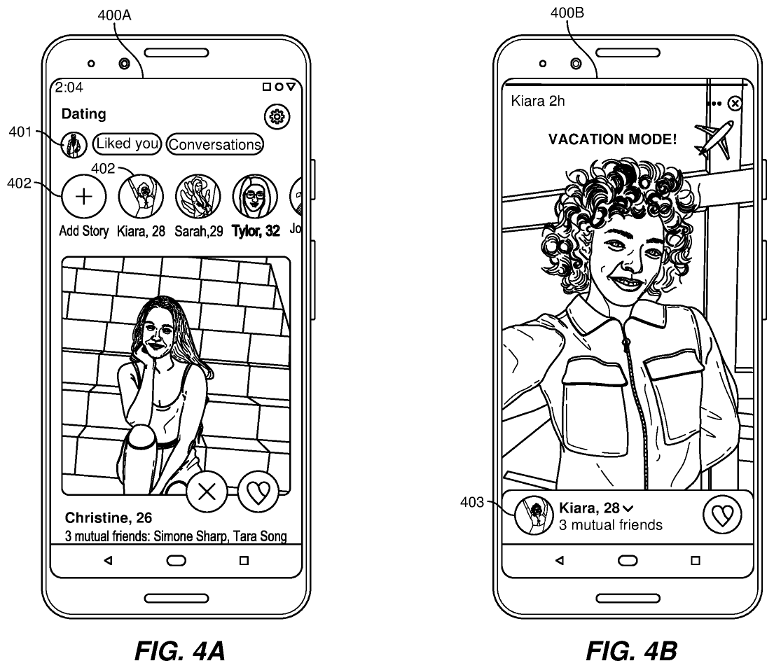

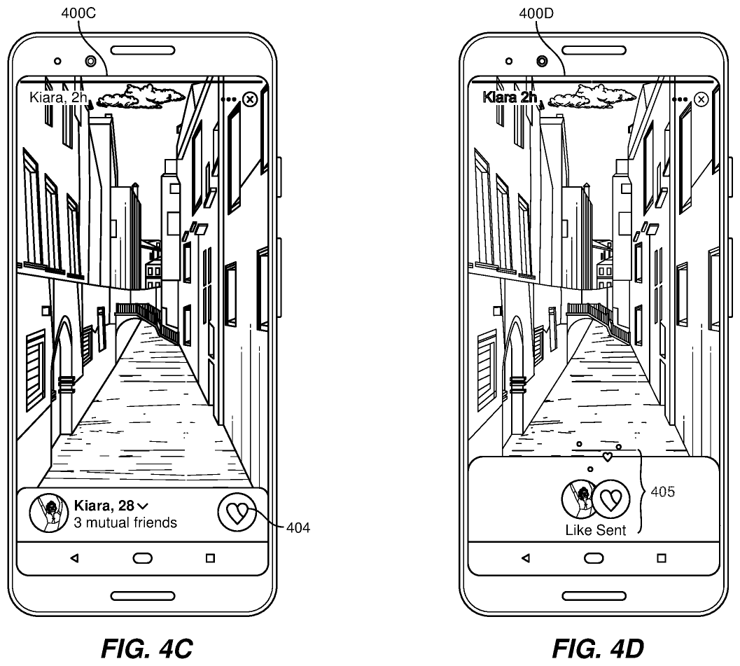

The GUI 300 may include a profile picture 301 of the user 107. This profile picture 301 corresponds to the user 107 who is a member of the online dating service 115. The GUI 300 may further include an interactive element 302 that provides access to a list of dating service users that liked or positively interacted with the user's content, as well as an interactive element 303 that provides access to conversations the user 107 is having with current matches and an interactive element 304 that provides access to the online dating service's corresponding application and/or GUI settings. Interactive element 305 may allow the user 107 to add a story or other content to their feed including videos, pictures, stories (that may themselves includes multiple forms of media content), text, audio tracks, interactive games, or other content. This content, as noted above, may be ephemeral, and may thus expire automatically after its lifespan is reached. The GUI 300 may further include pictures 306 of potential matches. As will be shown further below with regard to FIGS. 4A-4D, selecting one of these pictures 306 of potential matches may lead the user to the content posted by that potential match.

The content 307 (which may be an image) may depict another potential match for the user 107. The user may select the interactive element 309 to indicate that the user likes the image of the potential match, or may select interactive element 308 to indicate that the user would not like to see any more content posted by that potential match. Other interactive elements in GUI 300 may be locked on the bottom of the screen, or may be removed in cases where full-screen content is to be displayed. The bottom row of icons may include an interactive UI element 310 that allows users to navigate to their home screen or landing page, element 311 that allows users to see which potential matches they have “liked” or otherwise interacted with, element 312 that allows users to see groups of people including existing friends, matches, or potential matches, element 313 that shows notifications, and element 314 that allows users to access settings or other information related to the GUI 300 or to the application that generates the GUI.

FIGS. 4A-4D illustrate an embodiment of an animated GUI 400A in which a user (e.g., 107 of FIG. 1) explores and interacts with content produced by a potential match (see GUI instances 400A-400D). The GUI 400A, for example, may show a profile image 401 of the user 107, along with an interactive element 402 that allows the user to post their own content. The interactive element 403 allows the user to interact with ephemeral content produced by potential matches or by matches that were matched to the user. This interactive element 403 may allow the user 107 to converse with the potential matches or actual matches, and may also allow the user to interact with the ephemeral content produced by the matches or potential matches. In FIGS. 4B-4C, it is assumed that the user Kiara is a potential match, although in other cases, Kiara could be a matched user.

To see content posted by Kiara, the user 107 may select interactive UI element 403, which is associated with the user Kiara. The GUI may then shift to instance 400B, which shows a profile image of a person named Kiara, along with a full screen image or other posted content produced by Kiara. Selecting the posted content (e.g., clicking on or touching the full screen image) may move the GUI to instance 400C, which shows a post produced by Kiara. The user 107 may then select interactive element 404 which adds a like to the image shown in 400C. The GUI instance 400D may show an icon or animation 405 indicating that user 107 liked the image shown in 400C. Other interactions may be possible, including commenting or starting a private conversation.

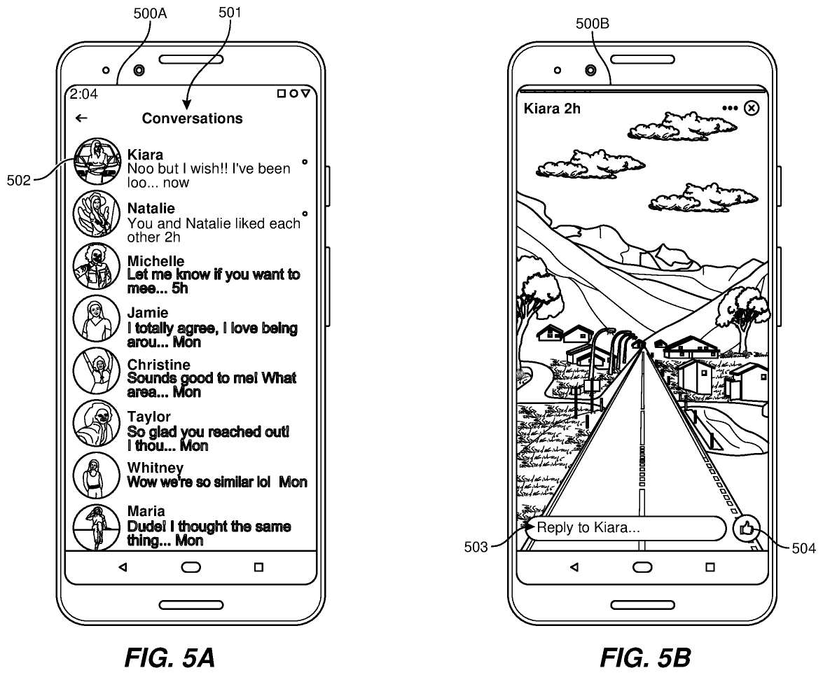

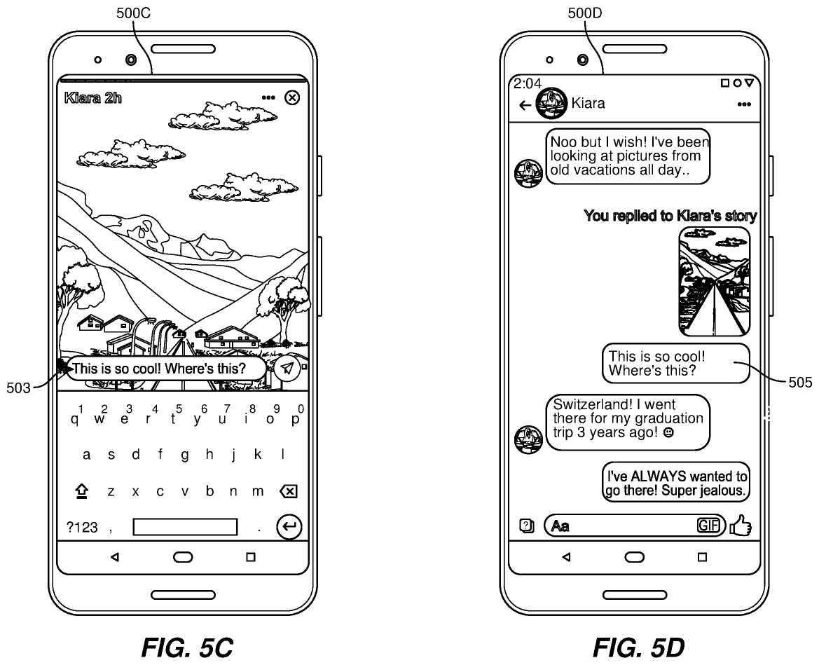

For instance, as shown in FIGS. 5A-5D, a user (e.g., 107) may comment on a post and may have a full conversation with another online dating service user. While in some embodiments, users may have conversations with potential matches, in other embodiments, users may only have conversations with matched users. In such cases, touching or otherwise selecting interactive UI elements may navigate the user to the potential matches' content, while selecting interactive UI element 303 may take the user to the matches' posted content. Thus, the GUI 300 may allow access to potential match's content in one screen, and may allow access to matched users' content in another screen. In cases where conversations are permitted with matched users, such as in GUI instance 500A, the conversations tab 501 may allow the user 107 to view their conversations with other matched users. In this example, Kiara is a matched user, although being a potential match is also an option. Kiara's profile picture 502 is shown next to a snippet of the conversation along with an indication of the elapsed time since the last comment in the conversation. By selecting Kiara's profile picture 502 or the conversation snippet, the user 107 may be navigated to the latest content (here, a full-screen image) produced by Kiara, as shown in GUI instance 500B.

Within GUI instance 500B, the user may reply to or comment on Kiara's post using comment box 503. Additionally or alternatively, the user 107 may interact with Kiara's post using a like button 504. If the user 107 selects the comment box 503, GUI instance 500C may bring up a virtual keyboard, allowing the user to type a comment. This comment may then be posted to a conversation string, as shown in 500D. The comment 505 may be posted and displayed in a string of comments that form a conversation between the users. In this manner, users may interact with each other in a progressive way that lets users take small steps into another person's life and allow the online dating service to determine, over time, whether other dating service members are good match, simply based on the users' interactions with each other's content.

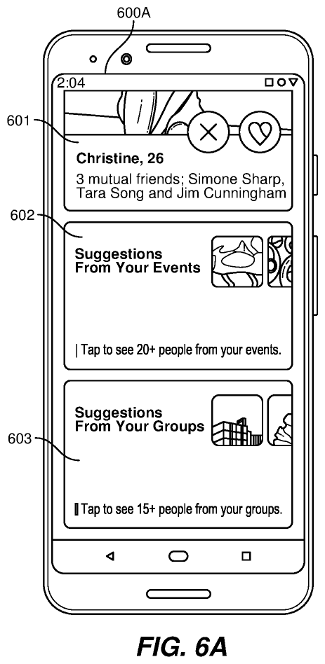

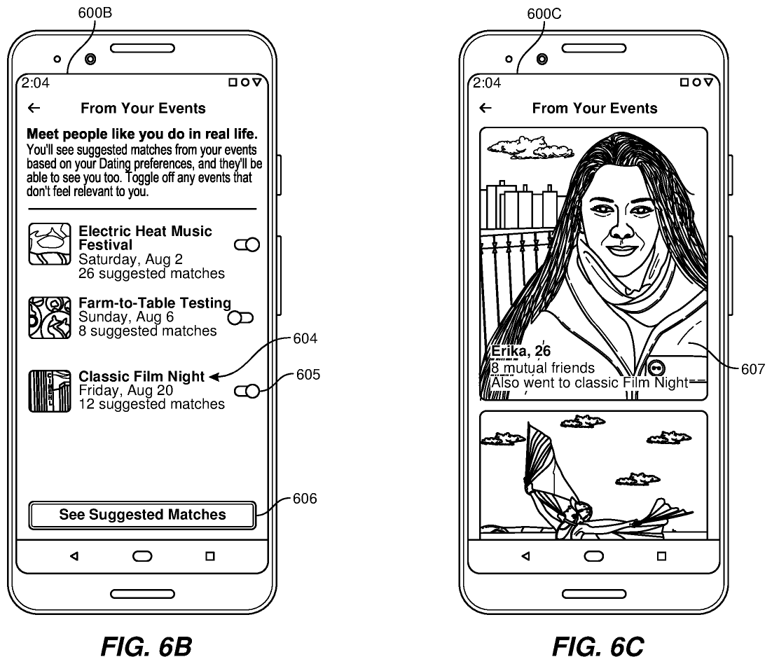

FIGS. 6A-6C illustrate an embodiment of different GUI instances that show how content may be aggregated in different manners. As noted above, content may be organized per user, showing, in each feed, the content produced by that user. In other cases, content from other potential matches may be gathered and aggregated according to a specified event, a specified hashtag, a specified location, or a specified topic. For example, GUI instance 600A illustrates one portion (601) that shows an image of a potential match, another portion (602) that shows suggested matches from events that the user likes or participates in, and another portion (603) that shows suggested matches from the user's groups. As shown in UI instance 600B, for example, the user may select portion 602 from 600A to view various events to which the user is subscribed. These events may include, for example, “Electric Heat Music Festival,” “Farm-to-Table Tasting,” “Classic Film Night,” and other groups. The user may toggle their subscription to these groups (e.g., 604) using toggle switch 605. For instance, as shown in 600B, the user may toggle their subscription to “Farm-to-Table Tasting” off. The user may select interactive UI element 606 to see suggested matches from an event (e.g., from the “Classic Film Night” group in 600C) and may select those matches (e.g., 607) in a manner similar to that described above with regard to FIG. 3, where a user selects a potential match and views content associated with that potential match.

Moreover, the user may also be part of groups, or may subscribe to certain hashtags. The user may be able to browse potential matches from those groups or from other potential matches that are subscribed to those hashtags. Still further, the user may specify a certain content type that they like to view (e.g., short videos). Other users that produce content of that type may then be presented in the user's feed of potential matches. Thus, whether it is finding other users that are in similar groups, or are subscribed to certain events, or are subscribed to certain hashtags, or want content from certain locations or on certain topics, users can find other potential matches that share those interests and/or subscriptions to certain topics or events. Users may even be able to specify a content type for the ephemeral content produced by others and have that content aggregated and presented so that the user can peruse the results looking for potential matches. As such, users may more easily be able to find other users with similar interests and, when such users are found, interact with their posts, get to know them better through conversations and interactions, and potentially, at some point later in time, match with those users.

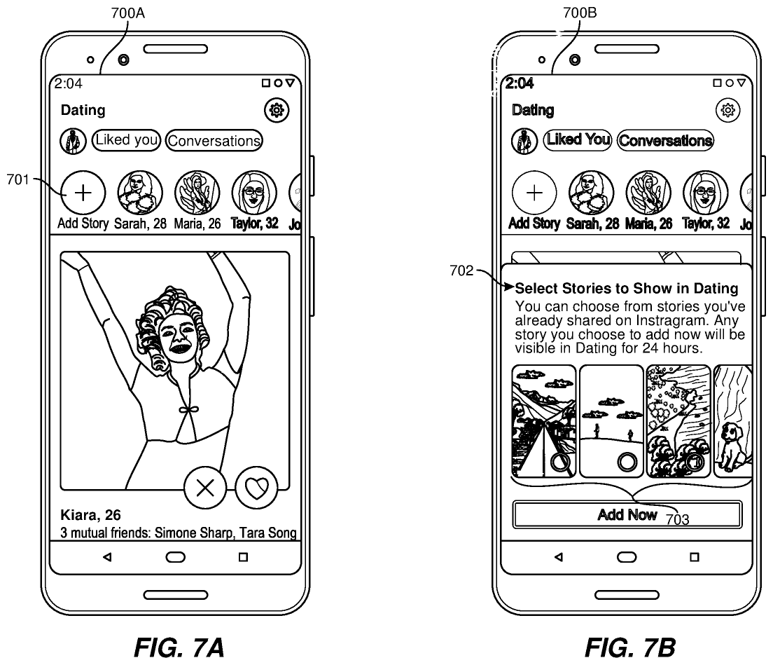

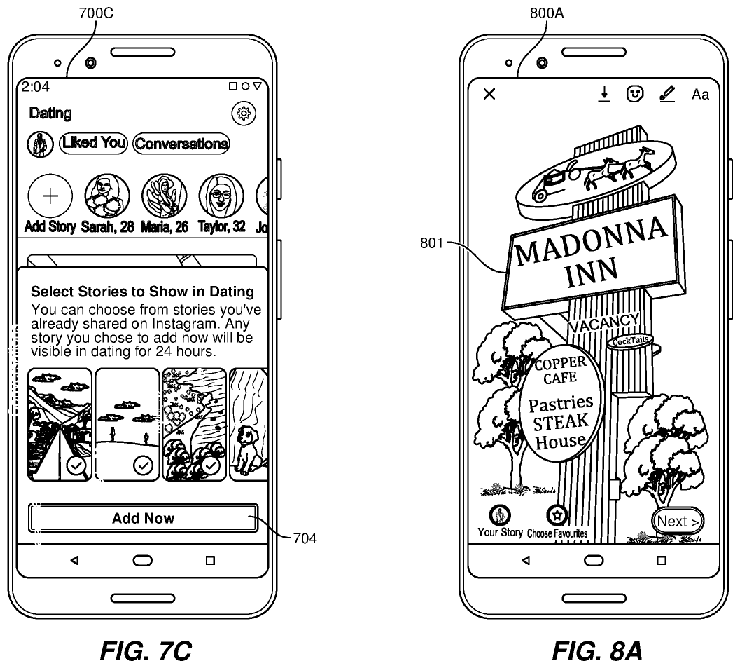

FIGS. 7A-7C illustrate an embodiment of an animated GUI at different stages in interaction. The GUI shown in instances 700A-700C show an embodiment in which a user accesses posts or other content from a different media platform (e.g., 120 of FIG. 1) and selects which of those posts or content to synchronize to the online dating service (e.g., 115 of FIG. 1). In one case, for example, the computer system 101 of FIG. 1 may determine that various portions of content were posted on a media platform that is different than the online dating service (e.g., content posted on media platform 120, which may be substantially any type of social media platform, video hosting site, picture hosting site, blog, etc.).

The computer system 101 may then receive an indication that the posted content is to be presented on the online dating service 115. In such cases, the online dating service 115 may be siloed from the media platform 120. As such, posted content and interactions within the online dating service 115 may be maintained and accessed separately from posted content provided for the media platform 120. In some cases, the posted content and interactions in the online dating service 115 remain within the dating service and are not accessible to non-members and may only be available to some members (e.g., matches) within the online dating service 115. Upon receiving the indication that the content is to be synchronized, the computer system 101 may synchronize the posted content to the online dating service 115 and may present the synchronized, posted content on the online dating service 115. Some or all of the interactions with the posted content may only be visible to users of the online dating service 115.

In GUI instance 700A of FIG. 7A, for example, the user may select interactive UI element 701 to add a story or other content. In this example, the story or other content may be taken from existing content posted to other media platforms, even though those media platforms are different from and may be siloed from the online dating service 115. In GUI instance 700B of FIG. 7B, the user may be presented with an interactive portion 702 that allows the user to select stories already shared on other media platforms. In some cases, the posts shown (e.g., 703) may all be from a single media platform, while in other cases, the posts shown 703 may be from multiple different media platforms. The user may peruse the available posts that were shared on other media platforms by scrolling through and then selecting those that they want to synchronize to the online dating service 115.

GUI instance 700C of FIG. 7C illustrates an example where the user has selected all three of the immediately visible posts. The user may then select interactive UI element 704 to add those posts to the online dating service 115. Upon synchronization, these posts will then appear in the user's feed, available for potential matches to see and interact with. Any subsequent interactions with these synchronized posts within the online dating service 115 may be held within the online dating service and may not be available outside the online dating service. In this manner, regardless of which other media platforms the user uses, the user can easily select which posts they want to provide in the online dating service 115, and the computer system 101 will automatically synchronize that content and make it available to potential matches within the online dating service 115.

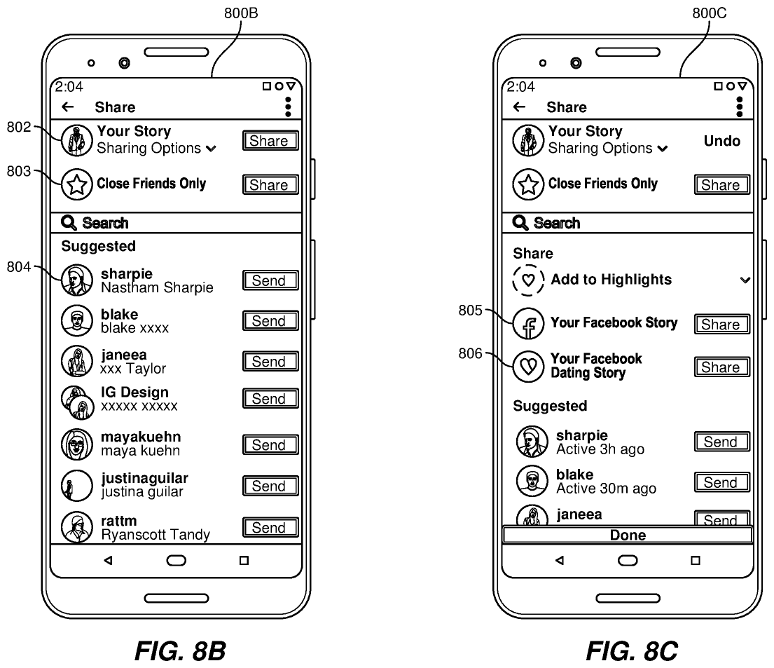

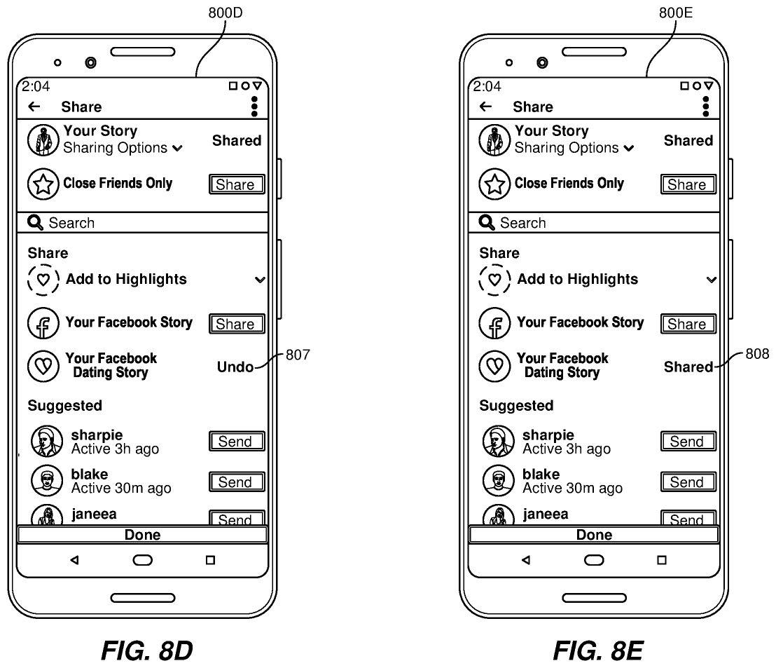

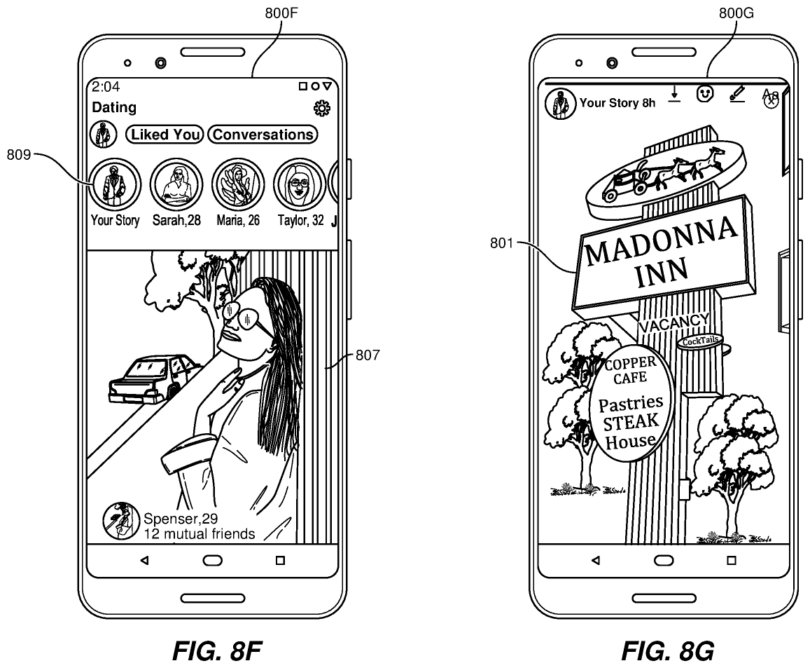

FIGS. 8A-8G illustrate an embodiment of an animated GUI with different GUI instances 800A-800G. GUI instance 800A, for example, shows a post 801 that was originally posted in a different media platform. This media platform may have its own application for stationary or mobile computing systems. Thus, the application and GUI shown in 800A are for an application and media platform that are different from the online dating service 115 of FIG. 1. In GUI instance 8006, the user may be presented with options that allow the user to share their story in that media platform to the online dating service 115. For instance, the GUI instance 8006 may allow users to share their stories publicly using option 802, share their stories with close friends only using option 803, or share their stories with specific users using option 804. GUI instance 800C presents the user with further sharing options, allowing the user to share with other media platforms using option 805, and further allowing the user to share with the online dating service 115 using option 806. In GUI instance 800D, the user may undo the sharing if they desire using option 807. GUI instance 800E indicates that the story (or other content) was shared on the online dating service 115. Then, if the user goes into the application associated with the online dating service 115, as shown in 800F, the user may see the shared story by selecting interactive UI element 809 which leads to the original post 801, but shown in the online dating service application.

Thus, from within other social media applications, users may be able to select which of their stories they synchronize to their profile on the online dating service 115. This content may then be automatically synchronized and made available for a specified lifespan. In some cases, the lifespan of the ephemeral content may be renewed when synchronized to the online dating service 115 and, as a result, may remain available longer on the online dating service 115 than on the original media platform. That is, even though the ephemeral content may expire on the original media platform, because the lifespan has been renewed with the synchronization to the online dating service 115, the original content may continue to live on the online dating service until the renewed lifespan has expired.

This synchronized content copied from a different social media platform may serve as an entry into a conversation with another user of the online dating service. Thus, not only can users produce and post content within the online dating service 115, the users can easily port existing content from other social media platforms of which they are members and allow potential matches and matches to see that content within the siloed online dating service 115. The user may have full control over which posts from which platforms are synchronized and seen by dating members. In some cases, controls that allow the user to indicate whether posted content from the other media platform(s) is to be synchronized to the online dating service are provided on both the media platform 120 and the online dating service 115. Thus, whether the user is looking at the application associated with the online dating service 115 or is looking at the application associated with the other media platform, controls may be provided that allow the user to select which content is synchronized from the other media platform to the online dating platform, or is synchronized from the online dating platform to the other media platform. In some cases, the user may select an option that automatically synchronizes all (or at least some) posts from one media platform to the online dating service 115.

As with the posts produced for the online dating service 115, the computer system 101 may track interactions with the synchronized posts and may use those tracked interactions to trigger a match between users of the online dating service (or at least as an indicator that a match may be appropriate). Thus, interactions with posts synchronized from other media platforms may also be an indicator of interest and potential chemistry between two potential matches in the online dating service 115.

In some embodiments, content produced by potential matches of the user may be presented in a specified order in the online dating service. For example, within the user's content feed, content produced by different potential matches may be placed more prominently or less prominently according to a determined ranking. For example, as shown in FIG. 3, profile pictures 306 or content 307 may be arranged in a certain order according to a specified ranking. The ranking may indicate the quality of match between the user and the potential match. Potential matches that are higher quality (i.e., more likely to become a match with the user) may have their content presented in more advantageous locations within the application associated with the online dating service 115. For instance, content 307 associated with Justin in FIG. 3 may have a higher ranking than content associated with John. Further, John may have a higher ranking than Tyler or Mark, etc. Thus, a ranking may be determined and applied to each potential match, thus presenting the user with those potential matches that have the highest likelihood of becoming a match or at least becoming a friend with the user.

In some cases, the ranking may be determined based on previous interactions between the user and the corresponding potential match. These interactions may include previous likes, comments, reply posts, text conversations, video chats, etc. Each interaction may contribute to the ranking, raising the ranking or lowering it based on the frequency of interactions, the type of interactions, the amount of time since the last interaction, or other factors. In some cases, the ranking may be weighted or scaled, depending on the interaction type. In other cases, the ranking may be determined based on the type of content that was posted. The computer system 101 of FIG. 1, for example, may implement machine learning or other automated techniques to automatically identify the content type posted by each user.

For example, the machine learning may identify not only that the content is an image or a video, but may determine the subject of the image or video or may determine what is happening in the picture or video. Then, based on this determination, the computer system may determine how likely the user is to want to view that content. If the determination indicates that the user will want to view the content, the ranking may be adjusted upward so that the potential match's post appears more prominently in the user's feed. If the determination indicates the opposite, the potential match's ranking may be lowered, and may be less prominent in the user's content feed.

In one embodiment, a system that corresponds to the Method 200 may be provided. The system may include at least one physical processor and physical memory comprising computer-executable instructions that, when executed by the physical processor, cause the physical processor to: identify one or more potential matches for a user of an online dating service, access at least a portion of ephemeral content produced by the user and, prior to matching at least one of the potential matches with the user, surface the accessed ephemeral content to at least one of the potential matches to facilitate conversation between the user and the potential matches.

In another embodiment, a non-transitory computer-readable medium may be provided that includes one or more computer-executable instructions that, when executed by at least one processor of a computing device, cause the computing device to: identify one or more potential matches for a user of an online dating service, access at least a portion of ephemeral content produced by the user, and prior to matching at least one of the potential matches with the user, surface the accessed ephemeral content to at least one of the potential matches to facilitate conversation between the user and the potential matches.

Accordingly, using the systems and methods described herein, a user may view content posted by potential matches and interact with that content as a way of getting to know that person. Then, over time as the user interacts with that person and with their content, the user may be matched to that person. This is a much more intuitive and personal way of getting to know someone before being matched with that person, as opposed to conventional systems where the user simply sees a picture and swipes left or right to match with or pass on that person, or where an impersonal algorithm makes back-end matching decisions. Moreover, the systems and methods described herein allow users to synchronize content across platforms, allowing the user to easily pull content from one social media platform and present it to potential matches within the online dating service, without fear of any comments or interactions with that post being visible to users outside the online dating platform.

### EXAMPLE EMBODIMENTS

Example 1: A computer-implemented method for facilitating conversation between potential matches in an online dating service may include identifying one or more potential matches for a user of an online dating service, accessing at least a portion of ephemeral content produced by the user and, prior to matching at least one of the potential matches with the user, surfacing the accessed ephemeral content to at least one of the potential matches to facilitate conversation between the user and the potential matches.

Example 2: The computer-implemented method of Example 1, further including determining that at least one of the potential matches has interacted with the surfaced ephemeral content produced by the user, and matching the potential match that interacted with the surfaced ephemeral content to the user based on the potential match's interaction with the user's surfaced ephemeral content.

Example 3: The computer-implemented method of any of Examples 1 and 2, wherein the step of matching the potential match that interacted with the surfaced ephemeral content to the user based on the potential match's interaction with the user's surfaced ephemeral content is performed after determining that the level of interaction with the user's surfaced ephemeral content is beyond a specified threshold minimum level of interaction.

Example 4: The computer-implemented method of any of Examples 1-3, wherein potential matches that have subsequently been matched with the user are permitted to provide one or more different types of interaction with the user's ephemeral content than are allowed with potential matches.

Example 5: The computer-implemented method of any of Examples 1-4, further comprising aggregating one or more portions of content from other users of the online dating service based on at least one of a specified event, a specified hashtag, a specified location, or a specified topic.

Example 6: The computer-implemented method of any of Examples 1-5, further including determining a content type for the accessed ephemeral content produced by the user, and aggregating the accessed ephemeral content based on the determined content type.

Example 7: The computer-implemented method of any of Examples 1-6, further comprising establishing a viability ranking for the potential matches based on the determined content type of the accessed ephemeral content.

Example 8: The computer-implemented method of any of Examples 1-7, wherein the online dating service includes a corresponding graphical user interface (GUI) that facilitates interaction with the online dating service, and wherein the GUI presents new potential matches for the user including the potential match's associated content.

Example 9: The computer-implemented method of any of Examples 1-8, wherein the GUI presents one or more portions of ephemeral content produced by matches that were matched to the user, allowing the user to converse with the matches and the ephemeral content produced by the matches.

Example 10: The computer-implemented method of any of Examples 1-9, wherein the GUI allows access to potential match's content in a first screen, and allows access to matched users' content in a second screen.

Example 11: A system comprising: at least one physical processor and physical memory comprising computer-executable instructions that, when executed by the physical processor, cause the physical processor to: identify one or more potential matches for a user of an online dating service, access at least a portion of ephemeral content produced by the user and, prior to matching at least one of the potential matches with the user, surface the accessed ephemeral content to at least one of the potential matches to facilitate conversation between the user and the potential matches.

Example 12: The system of Example 11, further comprising: determining that one or more portions of content were posted on a media platform that is different than the online dating service, receiving an indication that the posted content is to be presented on the online dating service, the online dating service being siloed from the media platform such that posted content and interactions within the online dating service are maintained and accessed separately from posted content provided for the media platform, upon receiving the indication, synchronizing the posted content to the online dating service, and presenting the synchronized, posted content on the online dating service, wherein interactions with the posted content are visible only to users of the online dating service.

Example 13: The system of Examples 11 or 12, wherein the posted content synchronized to the online dating service comprises an entry into a conversation with another user of the online dating service.

Example 14: The system of any of Examples 11-13, wherein one or more specified interactions with the posted content synchronized to the online dating service trigger a match between users of the online dating service.

Example 15: The system of any of Examples 11-14, wherein further interactions between the matched users related to the synchronized posted content remain siloed within the online dating service.

Example 16: The system of any of Examples 11-15, wherein content produced by potential matches of the user is presented in a specified order in the online dating service according to a determined ranking applied to each potential match.

Example 17: The system of any of Examples 11-16, wherein the ranking is determined based on one or more previous interactions between the user and the corresponding potential match.

Example 18: The system of any of Examples 11-17, wherein the ranking is determined according to an identified type of posted content, the posted content being automatically identified using machine learning.

Example 19: The system of any of Examples 11-18, wherein controls that allow the user to indicate whether posted content from the media platform is to be synchronized to the online dating service are provided on both the media platform and the online dating service.

Example 20: A non-transitory computer-readable medium comprising one or more computer-executable instructions that, when executed by at least one processor of a computing device, cause the computing device to: identify one or more potential matches for a user of an online dating service, access at least a portion of ephemeral content produced by the user, and prior to matching at least one of the potential matches with the user, surface the accessed ephemeral content to at least one of the potential matches to facilitate conversation between the user and the potential matches.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive data to be transformed, transform the data, output a result of the transformation to identify potential matches for a user, use the result of the transformation to access content produced by the user, and store the result of the transformation to surface content to the potential matches to facilitate a conversation. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A computer-implemented method comprising:
identifying, by a processor, one or more potential matches for a user of an online dating service;
accessing, by the processor, at least a portion of ephemeral content produced by the user;
prior to matching at least one of the potential matches with the user, surfacing, by the processor, the accessed ephemeral content to at least one of the potential matches to facilitate online interaction between the user and the potential matches;
prior to matching the user with the potential matches, tracking, by the processor, online interactions between the potential matches and the surfaced ephemeral content;
determining, by the processor, that at least two different forms of interaction have taken place between the potential matches and the surfaced ephemeral content and, for each form of interaction, tracking an amount of time spend on that form of interaction;
based on the cumulative tracked online interactions of the potential matches with the surfaced ephemeral content including the amount of time spent on each form of interaction, matching, by the processor, at least one of the potential matches to the user within the online dating service; and
controlling, by the processor, at least one electronic device associated with the user to dynamically add the match to a graphical user interface presented on the electronic device.

2. (canceled)

3. The computer-implemented method of claim 1, wherein the step of matching the potential match that interacted with the surfaced ephemeral content to the user based on the potential match's interaction with the user's surfaced ephemeral content is performed after determining that a level of interaction with the user's surfaced ephemeral content is beyond a specified threshold minimum level of interaction.

4. The computer-implemented method of claim 1, wherein potential matches that have subsequently been matched with the user are permitted to provide one or more different types of interaction with the user's ephemeral content than are allowed with potential matches.

5. The computer-implemented method of claim 1, further comprising aggregating one or more portions of content from other users of the online dating service based on at least one of a specified event, a specified hashtag, a specified location, or a specified topic. and

6. The computer-implemented method of claim 1, further comprising:
determining a content type for the accessed ephemeral content produced by the user; and
aggregating the accessed ephemeral content based on the determined content type.

7. The computer-implemented method of claim 6, further comprising establishing a viability ranking for the potential matches based on the determined content type of the accessed ephemeral content.

8. The computer-implemented method of claim 1, wherein the online dating service includes a corresponding graphical user interface (GUI) that facilitates interaction with the online dating service, and wherein the GUI presents new potential matches for the user including content produced by the potential match.

9. The computer-implemented method of claim 8, wherein the GUI presents one or more portions of ephemeral content produced by matches that were matched to the user, allowing the user to converse with the matches and the ephemeral content produced by the matches.

10. The computer-implemented method of claim 8, wherein the GUI allows access to potential match's content in a first screen, and allows access to matched users' content in a second screen.

11. A system comprising:
at least one physical processor; and
physical memory comprising computer-executable instructions that, when executed by the physical processor, cause the physical processor to:
identify one or more potential matches for a user of an online dating service;
access at least a portion of ephemeral content produced by the user;
prior to matching at least one of the potential matches with the user, surface the accessed ephemeral content to at least one of the potential matches to facilitate online interaction between the user and the potential matches;
prior to matching the user with the potential matches, track online interactions between the potential matches and the surfaced ephemeral content;
determine, by the processor, that at least two different forms of interaction have taken place between the potential matches and the surfaced ephemeral content and, for each form of interatction, tracking an amount of time spent on that form of interaction;
based on the cumulative tracked online interactions of the potential matches with the surfaced ephemeral content including the amount of time spent on each form of interaction, match at least one of the potential matches to the user within the online dating service; and
control at least one electronic device associated with the user to dynamically add the match to a graphical user interface presented on the electronic device.

12. The system of claim 11, wherein the computer-executable instructions further cause the physical processor to:
determine that one or more portions of content were posted on a media platform that is different than the online dating service;
receive an indication that the posted content is to be presented on the online dating service, the online dating service being siloed from the media platform such that posted content and interactions within the online dating service are maintained and accessed separately from posted content provided for the media platform;
upon receiving the indication, synchronize the posted content to the online dating service; and
present the synchronized, posted content on the online dating service, wherein interactions with the posted content are visible only to users of the online dating service.

13. The system of claim 12, wherein the posted content synchronized to the online dating service comprises an entry into a conversation with another user of the online dating service.

14. The system of claim 13, wherein one or more specified interactions with the posted content synchronized to the online dating service trigger a match between users of the online dating service.

15. The system of claim 14, wherein further interactions between the matched users related to the synchronized posted content remain siloed within the online dating service.

16. The system of claim 12, wherein content produced by potential matches of the user is presented in a specified order in the online dating service according to a determined ranking applied to each potential match.

17. The system of claim 16, wherein the ranking is determined based on one or more previous interactions between the user and the corresponding potential match.

18. The system of claim 16, wherein the ranking is determined according to an identified type of posted content, the posted content being automatically identified using machine learning.

19. The system of claim 12, wherein one or more user interface controls that allow the user to indicate whether posted content from the media platform is to be synchronized to the online dating service are provided on both the media platform and the online dating service.

20. A non-transitory computer-readable medium comprising one or more computer-executable instructions that, when executed by at least one processor of a computing device, cause the computing device to:
identify one or more potential matches for a user of an online dating service;
access at least a portion of ephemeral content produced by the user;
prior to matching at least one of the potential matches with the user, surface the accessed ephemeral content to at least one of the potential matches to facilitate online interaction between the user and the potential matches;
prior to matching the user with the potential matches, track online interactions between the potential matches and the surfaced ephemeral content; and
determine, by the processor, that at least two different forms of interaction have taken place between the potential matches and the surfaced ephemeral content and, for each form of interaction, tracking an amount of time spent on that for of interaction;
based on the cumulative tracked online interactions of the potential matches with the surfaced ephemeral content including the amount of time spent on each form of interaction, match at least one of the potential matches to the user within the online dating service; and
control at least one electronic device associated with the user to dynamically add the match to a graphical user interface presented on the electronic device.

21. The non-transitory computer-readable medium of claim wherein the step of matching the potential match that interacted with the surfaced ephemeral content to the user based on the potential match's interaction with the user's surfaced ephemeral content is performed after determining that a level of interaction with the user's surfaced ephemeral content is beyond a specified threshold minimum level of interaction.
